(19) United States
(12) Patent Application Publication
(10) Pub. No.: US 2009/0265480 A1
(43) Pub. Date: Oct. 22, 2009

(54) METHOD FOR DETERMINING COMPLEMENTARY DATA REGARDING AT LEAST ONE PIECE OF CONTENT, METHOD FOR TRANSMITTING SAID COMPLEMENTARY DATA, ASSOCIATED PROCESSING DEVICE AND APPLICATION SERVER

(75) Inventors: Vincent Verdot, Nozay (FR); Yann Gaste, Nozay (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/412,498

(22) Filed: Mar. 27, 2009

(30) Foreign Application Priority Data
Mar. 28, 2008 (FR) 0801689

(51) Int. Cl. G06F 15/16

(52) U.S. Cl. 709/245

(57) ABSTRACT

The invention pertains to a method for determining complementary data regarding at least one piece of content transmitted over a telecommunication network, said data being associated with at least one portion of said content's address, comprising the following steps:
an address (9) of at least one piece of content is received, as is complementary data (11,11′) associated with said address (9),
said received address (9) is compared with saved content addresses (10) in order to determine at least one shared address portion,
at least one piece of recurring complementary data is identified within the complementary data (11,11′) associated with said received address (9) and with said saved addresses (10) having a shared address portion, and
said shared address portion, as well as the identified associated recurring complementary data, are saved.

The invention further pertains to a method for transmitting said complementary data, as well as a data processing device and an application server for implementing such methods.

The invention pertains to a method for determining complementary data regarding at least one piece of content intended to be transmitted over a network, said data being associated with at least one portion of said content's address.

The invention further pertains to a method for transmitting complementary data based on at least one content address for content intended to be transmitted over a network.

The invention further pertains to a data processing device and an application server for implementing such methods.

Here, the term “content” refers to all data defining a television program, or video program, or audio program (whether radio or music), or multimedia program, or a digital data file.

Furthermore, the term “network” refers to any type of fixed or mobile network (such as a GSM, GPRS, UMTS, or WiFi network, or an Internet network, or a hard-wired network), capable of transmitting content, potentially by means of wires or wirelessly, to terminals which are coupled to said network, and to exchange data or messages with said terminals.

Any mode for transmitting content may be envisioned, particularly peer-to-peer (or “unicast”) mode, or point-to-multipoint (or “multicast”) mode, or broadcast mode.

Furthermore, the term “terminal” here refers to any type of equipment capable of receiving content from a network of the aforementioned type, and of exchanging data, messages and requests with said telecommunication network.

It may, for example, be a land-line or mobile telephone, a personal digital assistant (or PDA), a encrypted video or television program decoder, a set-top television program receiving device, a video or music program receiving device, or a desktop or portable computer, or a device on board a vehicle (such as an automobile, truck, bus, train, or likewise).

In order to satisfy a large number of customers, content providers offer their customers an increasingly broad range of customized services, such as interactive services, by means of application servers. The expanding number of these services gives the user an increasingly large number of choices.

Here, the term “application” refers to an application, whether interactive or not, which is loaded when it is executed in order to offer a service to the user of a terminal. Such an application may, for example, appear in the form of an executable script or executable program.

Interactive service applications may particularly include betting, voting, or purchasing applications; or applications for downloading or sharing content, such as telephone ringtones, text, videos, advertisements, or games.

Conventionally, the content transmitted by the content providers is associated with information, such as metadata, which is used to identify and describe this content.

The metadata are sets of elements or attributes which provide context, thereby enabling the application server to access the information, extract it, and understand it, so as to make it possible to manage and use the content, for example.

However, for some content, this metadata is optional.

Furthermore, whenever this metadata is associated with a piece of content, said metadata may be minimal, and require heavy analysis resources on the part of the application server.

Furthermore, this metadata is generally fixed and does not change, for example when the associated content is adapted to the interests of the users.

The purpose of the invention is therefore to improve upon known interactive services, by making it possible to provide information regarding a piece of content, said information being capable of automatically adapting over time, and requiring few analysis resources.

To that end, the object of the invention is a method for determining complementary data regarding at least one piece of content intended to be transmitted over a network and associated with at least one portion of said content's address, comprising the following steps:
An address of at least one piece of content is received, as is complementary data associated with said address,
said received address is compared with saved content addresses in order to determine at least one shared address portion,
at least one piece of recurring complementary data is identified within the complementary data associated with said received address and with said saved addresses having a shared address portion, and
said shared address portion, as well as the identified associated recurring complementary data, are saved.

Preferentially, both the addresses and associated complementary data, as well as the shared address portions and associated recurring complementary data, are saved in memorization means comprising a knowledge base.

Advantageously, said network is an IMS multimedia subsystem network which implements the IP Internet communication protocol.

Advantageously, said method for determining complementary data comprises the following steps:
the communications over said network are analyzed so as to make it possible to extract complementary data associated with a content address,
the extracted complementary data is transmitted, and
the transmitted extracted complementary data is saved.

Another object of the invention is a method for transmitting complementary data based on at least one content address for content intended to be transmitted over a network, comprising the following steps:
at least one content address is received,
it is determined whether said received address includes at least one address portion shared with saved address portions associated with complementary data, said complementary data being determined via a method for determining complementary data regarding at least one piece of content intended to be transmitted over a network and associated with at least one portion of said content's address, comprising the following steps:
   an address of at least one piece of content is received, as is complementary data associated with said address,
   said received address is compared with saved content addresses in order to determine at least one shared address portion,
   at least one piece of recurring complementary data is identified within the complementary data associated with said received address and with said saved addresses having a shared address portion, and
   said shared address portion, as well as the identified associated recurring complementary data, are saved.
the complementary data associated with the determined address portions is transmitted.

Another object of the invention is a data processing device, comprising at least one processing means for:
receiving an address of at least one piece of content, as well as complementary data associated with said received address,
comparing said received address with saved addresses in order to determine at least one shared address portion,
identifying at least one piece of recurring complementary data within the complementary data associated with said received address and with said saved addresses having a shared address portion, and
saving said shared address portion, as well as the identified associated recurring complementary data.

A further object of the invention is a data processing device, comprising at least one processing means for:
receiving at least one content address,
determining whether said received address includes at least one address portion shared with saved address portions associated with complementary data, said complementary data being determined via a method for determining complementary data regarding at least one piece of content intended to be transmitted over a network and associated with at least one portion of said content's address, comprising the following steps:
   an address of at least one piece of content is received, as is complementary data associated with said address,
   said received address is compared with saved content addresses in order to determine at least one shared address portion,
   at least one piece of recurring complementary data is identified within the complementary data associated with said received address and with said saved addresses having a shared address portion, and
   said shared address portion, as well as the identified associated recurring complementary data, are saved.
transmitting the complementary data associated with the determined address portions.

A further object of the invention is an application server, comprising at least one processing means for:
receiving an address of at least one piece of content, as well as complementary data associated with said address, and
transmitting a request for determining recurring complementary data associated with at least one portion of said received address, said request comprising both said received address and the associated complementary data.

A further object of the invention is an application server, comprising at least one processing means for:
receiving at least one content address,
sending a request to generate complementary data based on said address, said request comprising said address, and
receiving complementary data associated with at least one portion of said address, said complementary data being determined via a method for determining complementary data regarding at least one piece of content intended to be transmitted over a network and associated with at least one portion of said content's address, comprising the following steps:
   an address of at least one piece of content is received, as is complementary data associated with said address,
   said received address is compared with saved content addresses in order to determine at least one shared address portion,
   at least one piece of recurring complementary data is identified within the complementary data associated with said received address and with said saved addresses having a shared address portion, and
   said shared address portion, as well as the identified associated recurring complementary data, are saved.

Other characteristics and advantages will become apparent upon reading the following description, given as an example and non-limiting in nature, with reference to the attached drawings, in which:

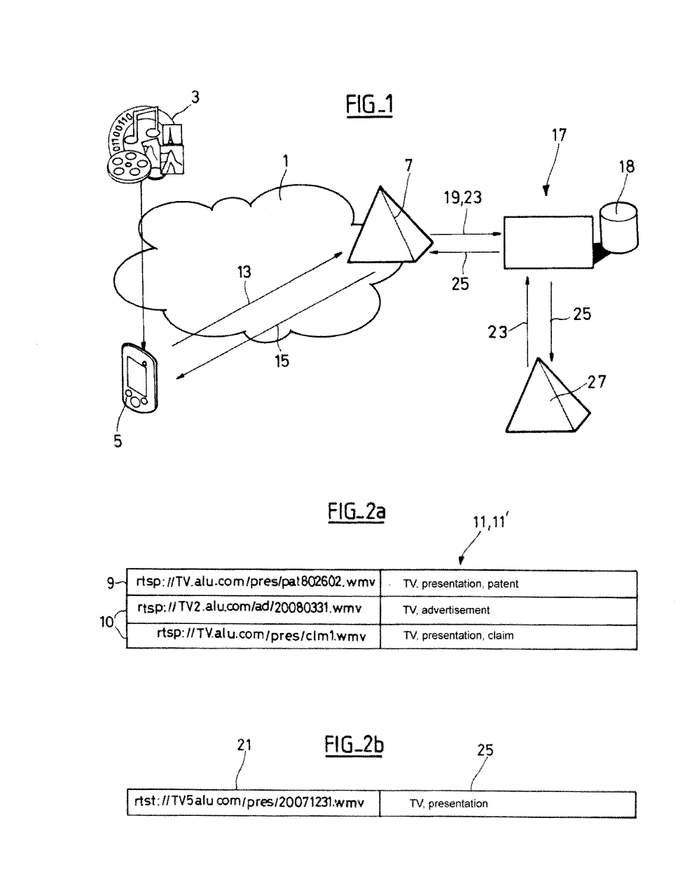

FIG. 1 schematically depicts the general structure of a system for implementing a method for determining complementary data in accordance with the invention and a method for transmitting said complementary data in accordance with the invention,

FIG. 2a depicts an example determination of complementary data,

FIG. 2b depicts an example transmission of complementary data,

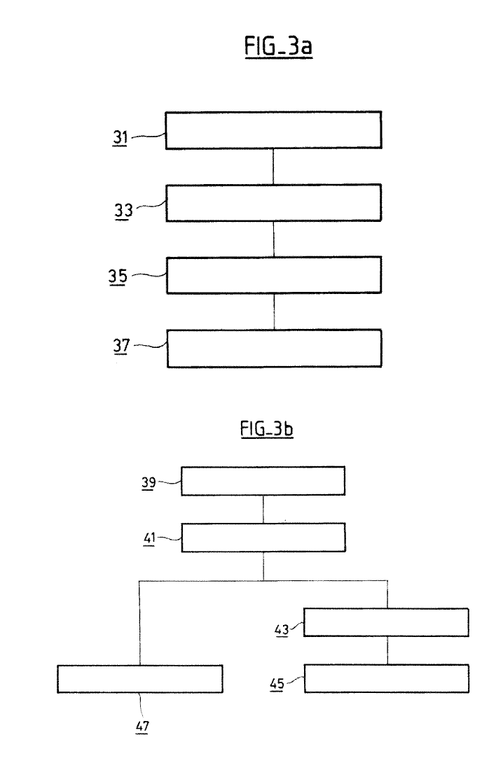

FIG. 3a depicts the successive steps of a method for determining complementary data in accordance with the invention, and

FIG. 3b depicts the successive steps of a method for generating the transmission of said complementary data in accordance with the invention.

FIG. 1 depicts a network 1, for example a fixed or mobile telecommunication network (such as a GSM, GPRS, UMTS or WiFi network, or an Internet network, or a hard-wired network).

The network 1 may be any type of network capable of transmitting content, potentially by means of wires or wirelessly, to terminals which are coupled to said network, and to exchange data or messages with said terminals.

Any mode for transmitting content may be envisioned, particularly peer-to-peer (or “unicast”) mode, or point-to-multipoint (or “multicast”) mode, or broadcast mode.

Preferably, the network 1 implements the IP (Internet Protocol) Internet communication protocol.

The network 1 may thereby transmit information in the form of packets, with each packet comprising a header indicating an IP address of the recipient of the packets, so that the packets may take various paths to reach the recipient.

A content provider 3 is connected to the network 1 and transmits content over the network 1, such as in the form of a stream, to terminals 5 capable of receiving and displaying, such as on a screen, the transmitted content.

The content transmitted by the network 1 may be audiovisual content, such as television or radio programs, or videos, or games.

The terminal 5 for example, be a land-line or mobile telephone, a personal digital assistant (or PDA), a encrypted video or television program decoder, a set-top television program receiving device, a video or music program receiving device, or a desktop or portable computer, or a device on board a vehicle (such as an automobile, truck, bus, train, or likewise).

The terminal 5 is further capable of exchanging data, messages, and requests with the telecommunication network 1, and in particular with an application server 7 connected to the network 1, as shall be described later.

Whenever the terminal 5 displays a piece of content received from a content provider 3 via the network 1, a user of the terminal 5 may obtain a service related to the received content, such as to mark and/or share the received content.

To do so, the terminal 5 comprises at least one processing means for:
selecting the received content,
saving an address 9 (see FIG. 2a) of the selected content,
generating and associating with the address 9 complementary data 11, such as the title of the selected content, the television channel that transmitted the content, the format of the content or any other description data and/or information on the content, and
transmitting over the network 1 the address 9 and the associated complementary data, such as a service request 13. This request 13 may further comprise at least one piece of identification data for the terminal 5 that generated the request 13.

The address 9 of the content is advantageously a string of characters encoded using a character encoding standard, such as ASCII for “American Standard Code for Information Interchange”.

In one preferential embodiment, the address 9 is a uniform resource located, or URL, which makes it possible to indicate how to access the content that it identifies.

Take for example the following fictional URL: rtsp://TV.alu.com/pres/pat802602.wmv, see FIG. 2a.

This URL includes:
the indication of the communication protocol used to access this resource, here rtsp for Real Time Streaming Video, followed by the mandatory separation character and
a set of parameters for locating the resource hosting the content on the network, said set of parameters comprising:
   the character string “//”, used for specifying the resource hosting the content before the content access path,
   the domain name of the resource that hosts the content, here “TV.alu.com” pertaining to the television channel “TV”,
   the absolute path for accessing the content, said path beginning with the character “/”; here, for example, the access path is “/pres/pat802602”,
   an extension, here “.wmv”, which lets the server 7 know how to process the content.

In the remainder of the description, the term “address portion” refers to any parameter which is both contained between the protocol indication and the extension and also delimited by a “/” character. In the example above, the address portions are therefore “TV.alu.com”, “pres”, and “pat802602”.

Preferentially, the application server 7 comprises at least one processing means for receiving the request 13, and for processing this request 13.

By processing the request 13, the server 7 accesses the address 9 of the selected content, the associated complementary data 11, and potentially the identification data for identifying the terminal 5 that generated the request 13.

It may be provided that for a single address 9 of a piece of content, the server 7 receives various associated complementary data 11 generated by users of different terminals.

If so, the server 7 comprises at least one processing means for analyzing the received complementary data 11 in order to determine a set 11′ of keywords which are relevant to the information contained within said complementary data 11.

More precisely, the server 7 may, for example, be capable of:
identifying shared complementary data within the received complementary data 11,
checking whether the number of pieces of complementary data 11 which include identified shared data meet a preset threshold, and
if they do, associating the shared complementary data, forming a set 11′ of keywords, with the address 9.

The server 7 may further comprise at least one processing means to sort the set 11′ of keywords, so as to rank the keywords based on a preset order.

Preferentially, the server 7 additionally comprises at least one processing means for sending a service response 15 to the terminal 5 that generated the request 13. This service response 15 may comprise a confirmation message, or an interrogation message, related to the provided service.

Preferably, the server 7 further comprises content management means.

Furthermore, the server 7 further comprises at least one processing means for transmitting a request 19 to a data processing device 17 of the network 1, said request being intended to determine recurring complementary associated with at least one portion of address 9 “rtsp://TV.alu.com/pres/pat802602.wmv”

This request 19 comprises both the address 9 and the associated complementary data 11.

Advantageously, the transmitted complementary data is shared complementary data forming the set 11′ of keywords, such as in this case the keywords “TV, presentation, patent”, associated with the address 9.

In one advantageous embodiment, the processing device 17 may be coupled to the server 7.

According to the invention, the processing device 17 comprises at least one processing means for:
receiving an address 9 of a piece of content, here “rtsp://TV.alu.com/pres/pat802602.wmv”, and the complementary data 11, 11′ associated with the address 9, here “TV, presentation, patent”, transmitted, for example, by the server 7 within the request 19,
comparing the received address 9 with saved identification data 10 “rtsp://TV2.alu.com/ad/20080331.wmv” and “rtsp://TValu.com/pres/clm1.wmv” in the example shown in FIG. 2a, in order to determine shared address portions, here “TV.alu.com”, and “pres”,
identifying at least one piece of recurring complementary data
   both within the complementary data 11,11′ “TV, presentation, patent” associated with the received address 9 and “TV, advertisement” and “TV, presentation, claim” associated with the identification data 10 having the shared address portion “TV.alu.com”, and
   within the complementary data 11.11′ “TV, presentation, patent” associated with the received address 9 and “TV, presentation, claim” associated with the address 10 having the shared address portion “pres”, and
saving the shared address portions “TV.alu.com” and “pres” and the identified associated recurring complementary data “TV” and “presentation”, respectively.

Preferentially, the processing device 17 saves both the addresses 9, 10 and associated complementary data 11, 11′, as well as the shared address portions and recurring complementary data, within memorization means. These memorization means may comprise a knowledge base 18. This knowledge base 18 may be internal to or external to the processing device 17.

Advantageously, the complementary data 11,11′ saved in the knowledge base 18 were generated by the users of a group or a community, so that the identified recurring complementary data are personalized and are adapted to the users of that group.

This knowledge base 18 is enriched by the complementary data 11,11′ added by the users of the group. The more the users transmit identification data and associated complementary data, the greater the number of shared address portions and identified associated recurring complementary data.

Advantageously, the network 1 is a multimedia subsystem network using the IP protocol “IMS” for Internet protocol Multimedia Subsystem, and in such a case makes it possible to provide fixed or mobile multimedia services, such as Voice over IP (VoIP), instant messaging, or presence information.

Advantageously, a component integrated into the IMS network comprises at least one processing means to analyze communications over the IMS network so as to make it possible to extract complementary data associated with an address of at least one piece of content selected by a user of a terminal. The network component then transmits the advantageously extracted complementary data to the processing device 17.

Naturally, the processing device 17 comprises at least one processing means for:

receiving extracted complementary data transmitted by the network component, and saving the extracted complementary data into the knowledge base 18.

The network component may, for example, be a “PNA” for “Presence Network Agent”.

The network component may be embodied in the form of an IMS proxy server, or an IMS application server.

Thus, whenever a user sends an address 9 of a piece of content by an IMS communication means, such as via an textual instant message, an email, or a voice call, the information contained within this IMS communication means may be transmitted to the processing device 17, so that it may also be associated with the address 9. The knowledge base 18 may thereby be enriched automatically.

It is obvious that the user will have previously given his agreement for the use of the information that he is transmitting via the IMS network. In this manner, the processing device 17 may, in addition to the complementary data 11,11′ voluntarily generated by the user via the server 7, make use of information traveling via the IMS communication means.

Preferentially, the server 7 and/or a third-party application server 27 of the network 1 comprises at least one processing means for:
receiving at least one content address 21, “rtsp://TV5.alu.com/pres/20071231.wmv” in the example depicted in FIG. 2b, for example one transmitted by a terminal of the network 1 within a service request,
sending a request 23 to transmit complementary data 25 based on the address 21, said request 23 comprising the address 21, and
receiving complementary data 25 associated with at least one portion of the address 21.

Advantageously, the server 7, 27 that transmitted the request 23 is capable of making use of the received complementary data 25.

Advantageously, the processing device 17 comprises at least one processing means for:
receiving a content address 21, for example the fictional address “rtsp://TV5.alu.com/pres/20071231.wmv”, transmitted within a request 23 to transmit complementary data,
determining whether the received address 21 comprises at least one address portion shared with the saved address portions, here “TV.alu.com” and “pres”, respectively associated with the complementary data “TV” and “presentation”, and
transmitting the recurring complementary data 25 “TV” and “presentation”, respectively associated with the determined address portions “TV.alu.com” and “pres”.

Advantageously, the processing device 17 comprises at least one processing means for:
checking whether the received address 21 is already saved, such as in the knowledge base 18, and
transmitting the complementary data associated with this address 21, when it is already saved.

In one variant embodiment, the processing device 17 comprises at least one processing means for automatically deleting the data saved in the knowledge base 18 if the usage quota, compared to the availability time, is below a preset threshold.

Consequently, the knowledge base 18 is not burdened with obsolete data.

As depicted in FIG. 3a, the method for determining complementary data regarding at least one piece of content intended to be transmitted over a network 1 and associated with at least one portion of the content's address comprises multiple steps, detailed above.

According to the invention, the processing device 17, during a step 31, receives both an address 9 of at least one piece of content, as well as the complementary data 11, 11′ associated with the address 9, which may for example be transmitted by an application server 7 within a request 19 to determine complementary data.

Following step 31, the processing device 17 may save the identification data 9 and the associated complementary data 11, 11′. Advantageously, the data is saved in the knowledge base 18.

During step 33, the processing device 17, compares the received address 9 with the saved addresses 10, in order to determine at least one shared address portion.

Then during step 35, the processing device 17 identifies at least one piece of recurring complementary data within the complementary data associated with the received address 9 and with the saved addresses 10 that have a shared address portion.

Next, during step 37, the processing device 17 saves the shared address portion and the identified associated recurring complementary data. Advantageously, the data is saved in the knowledge base 18.

Preferentially, the network 1 is a multimedia subsystem network using the IP protocol “IMS” for Internet protocol Multimedia Subsystem, and a component integrated into the IMS network advantageously analyzes the communications over the network 1 in such a way as to make it possible to extract complementary data associated with the address 9, then transmit the extracted complementary data to the processing device 17. The processing device 17 then receives this additional data during step 31.

This method for determining complementary data is advantageously implemented by a system comprising at least one data processing device 17 and at least one application server 7 as described above.

As depicted in FIG. 3b, the method for transmitting complementary data based on at least one content address comprises multiple steps detailed above.

During a step 39, the processing device 17 receives at least one content address 21, transmitted, for example, by an application server 7, 27 of the network 1 within a request 23 to transmit complementary data.

The processing device 17 may check whether the received address 21 is saved, such as within the knowledge base 18, in which cause it may be provided that the processing device is capable of comparing the saved identification data with the received address, which is step 41.

For example, if the received address 21 is new, the processing device 17 determines, during step 43, whether the received address 21 comprises at least one address portion shared with address portions saved, for example, in the knowledge base 18.

Next, during step 45, the processing device 17 transmits the saved recurring complementary data with the determined address portions.

Advantageously, following step 41 whenever the received address 21 is already saved, such as within the knowledge base 18, the processing device 17 transmits the complementary data associated with that address 21 during step 47.

This method for determining complementary data is advantageously implemented by a system comprising at least one data processing device 17 and at least one application server 7, 27 as described above.

It should therefore be understood that with such a method, the processing device automatically provides information that may be used directly by the application server and adapted to users.

Additionally, this information is not fixed, and may vary over time depending on users' activity and their interest in a given piece of content.

The more address portions associated with complementary data are saved, the greater the ability to provide relevant information regarding a given piece of content based on the address of that content, even if it had never been saved before, such as within the knowledge base.

1. A method for determining complementary data regarding at least one piece of content intended to be transmitted over a network and associated with at least one portion of said content's address, comprising the following steps:
an address (9) of at least one piece of content is received, as is complementary data (11,11′) associated with said address (9),
said received address (9) is compared with saved content addresses (10) in order to determine at least one shared address portion,
at least one piece of recurring complementary data is identified within the complementary data (11,11′) associated with said received address (9) and with said saved addresses (10) having a shared address portion, and
said shared address portion, as well as the identified associated recurring complementary data, are saved.

2. A method according to claim 1, wherein both the addresses (9,10) and associated complementary data (11,11′), as well as the shared address portions and associated recurring complementary data, are saved in memorization means comprising a knowledge base (18).

3. A method according to claim 1, wherein said network is an IMS multimedia subsystem network which implements the IP Internet communication protocol.

4. A method according to claim 3, comprising the following steps:
the communications over said network are analyzed so as to make it possible to extract complementary data associated with a content address,
the extracted complementary data is transmitted, and
the transmitted extracted complementary data is saved.

5. A method for transmitting complementary data based on at least one content address for content intended to be transmitted over a network, comprising the following steps:
at least one content address (21) is received,
it is determined whether said received address (21) includes at least one address portion shared with saved address portions associated with complementary data, said complementary data being determined via a method for determining complementary data regarding at least one piece of content intended to be transmitted over a network and associated with at least one portion of said content's address, comprising the following steps:
an address (9) of at least one piece of content is received, as is complementary data (11,11′) associated with said address (9),
said received address (9) is compared with saved content addresses (10) in order to determine at least one shared address portion,
at least one piece of recurring complementary data is identified within the complementary data (11,11′) associated with said received address (9) and with said saved addresses (10) having a shared address portion, and
said shared address portion, as well as the identified associated recurring complementary data, are saved.
the complementary data (25) associated with the determined address portions is transmitted.

6. A data processing device, comprising at least one processing means for:
receiving an address (9) of at least one piece of content, as well as complementary data (11,11′) associated with said received address (9),
said received address (9) is compared with saved content addresses (10) in order to determine at least one shared address portion,
at least one piece of recurring complementary data is identified within the complementary data (11,11′) associated with said received address (9) and with said saved addresses (10) having a shared address portion, and
saving said shared address portion, as well as the identified associated recurring complementary data.

7. A data processing device, comprising at least one processing means for:
receiving at least one content address (21),
it is determined whether said received address (21) includes at least one address portion shared with saved address portions associated with complementary data, said complementary data being determined via a method for determining complementary data regarding at least one piece of content intended to be transmitted over a network and associated with at least one portion of said content's address, comprising the following steps:
an address (9) of at least one piece of content is received, as is complementary data (11,11′) associated with said address (9),
said received address (9) is compared with saved content addresses (10) in order to determine at least one shared address portion,
at least one piece of recurring complementary data is identified within the complementary data (11,11′) associated with said received address (9) and with said saved addresses (10) having a shared address portion, and
said shared address portion, as well as the identified associated recurring complementary data, are saved.
transmitting the complementary data (25) associated with the determined address portions.

8. An application server, comprising at least one processing means for:
receiving both an address (9) of at least one piece of content, as well as complementary data (11,11′) associated with said address (9),
transmitting a request (19) for determining recurring complementary data associated with at least one portion of said received address (9), said request (19) comprising both said received address (9) and the associated complementary data (11, 11′).

9. An application server, comprising at least one processing means for:
receiving at least one content address (21),
sending a request (23) for transmitting complementary data based on said address (21), said request (23) comprising said address (21), and
receiving complementary data (25) associated with at least one portion of said address (21), said complementary data being determined via a method for determining complementary data regarding at least one piece of content intended to be transmitted over a network and associated with at least one portion of said content's address, comprising the following steps:
an address (9) of at least one piece of content is received, as is complementary data (11,11′) associated with said address (9),
said received address (9) is compared with saved content addresses (10) in order to determine at least one shared address portion,
at least one piece of recurring complementary data is identified within the complementary data (11,11′) associated with said received address (9) and with said saved addresses (10) having a shared address portion, and
said shared address portion, as well as the identified associated recurring complementary data, are saved.
